(19) United States
(12) Patent Application Publication
(10) Pub. No.: US 2025/0163737 A1
(43) Pub. Date: May 22, 2025

(54) Protective Cabinet

(71) Applicant: ABC Manufacturing, LLC dba ABC Wash Systems, Rochester Hills, MI (US)

(72) Inventor: Ismael Mosa-Basha, Rochester Hills, MI (US)

(21) Appl. No.: 18/953,825

(22) Filed: Nov. 20, 2024

Related U.S. Application Data
(60) Provisional application No. 63/602,145, filed on Nov. 22, 2023.

(51) Int. Cl. E05C 17/12; G09F 9/30

(52) U.S. Cl. CPC E05C 17/12; G09F 9/30

(57) ABSTRACT

A cabinet comprising a back portion having a first, second, and third edge, a first door connected to the back portion via one or more hinges including a first edge of the first door and a second edge of the first door, a second door connected to the back portion via one or more hinges wherein the one or more hinges are located in contact with the first edge of the first door and a first edge of the second door; and one or more retaining arm assemblies located at a third edge of the back portion, wherein one or more retaining arm assemblies are capable of moving between a disengaged position and an engaged position.

### CLAIM OF PRIORITY

This application claims the benefit of the priority date of U.S. Provisional Application Ser. No. 63/602,145, filed on Nov. 22, 2023. The contents of that application are hereby incorporated by reference herein in their entirety and for all purposes.

### FIELD

The present teachings relate to cabinets for securing and protecting electronic devices while allowing for simplified access to signage.

### BACKGROUND

Car washes and other drive-through retail settings utilize a variety of signage devices to convey information to customers. Many of these sigs are static without the use of lighting or digital aspects. Many others are electronic in nature or at least include lighting or digital content. Such signage is often contained within cabinet-type structures in an effort to protect the signs and/or electrical circuitry from environmental elements (rain, cold, heat, dryness). This need is even more pronounced in a car wash setting where water exposure is constant.

Some of the issues associated with these types of protective cabinets is the ability to access any electrical circuitry, modify sign content, replace electrical or static signage devices, easily change a message, or to maximize sign space with minimal floor footprint all while providing sufficient protection to the signage.

The teachings herein are directed to cabinet structures that are capable of reducing difficulty to access the signs and devices within the cabinets while also maximizing sign space and simplifying changing of the signage.

### SUMMARY

The present teachings relate to a cabinet comprising: a back portion having a first, second, and third edge; a first door connected to the back portion via one or more hinges including a first edge of the first door and a second edge of the first door; a second door connected to the back portion via one or more hinges wherein the one or more hinges are located in contact with the first edge of the first door and a first edge of the second door; one or more retaining arm assemblies located at a third edge of the back portion, wherein one or more retaining arm assemblies are capable of moving between a disengaged position and an engaged position; a space formed in the back portion for receiving a screen. When the one or more retaining arm assemblies is in the engaged position the first door, the second door, or both are secured in an open position and when the one or more retaining arm is in the disengaged position, the first door, the second door, or both are able to move between an open and closed position.

The one or more retaining arm assemblies may include a retaining arm, the retaining arm including a projection that is capable of being received by a slot portion located along a third edge of the first door and second door when in the engaged position.

The one or more retaining arm assemblies may include a parallel wall having an opening located therein for receiving a fastener.

The fastener may include one or more bolts.

The retaining arm may swing about the one or more bolts to move from the disengaged position to the engaged position.

The first and second doors may be capable of opening in the disengaged position and extend around the back portion to be fastened together behind the back portion.

The screen may be electronic and capable of displaying changing visuals.

The screen may be static and capable of displaying a consistent visuals until manually changed.

The cabinet may include a latch for maintaining the first and second door in a closed position.

The latch may include a hook and catch for receiving the hook.

The hook may be located on the second door and the catch is located on the first door.

The teachings herein are further directed to a cabinet comprising: a first door including a first edge of the first door and a second edge of the first door; a second door connected to the first door via one or more hinges wherein the one or more hinges are located in contact with the first edge of the first door and a first edge of the second door; one or more knob structures for mechanically interlocking the second edge of the first door with a second edge of the second door; a first ledge portion attached to an edge of the second door, the first ledge portion including one or more openings; a space formed in the first door for receiving an electronic device, the space being defined by a plurality of wall structures that are capable of preventing lateral movement and provide support from below to maintain the electronic device within the space. The wall structures include a plurality of extending walls that extend away from the second edge of the first door and a plurality of corner walls that are connected to the extending walls but lie in a substantially perpendicular relationship with the plurality of extending walls.

The ledge portion may be attached to a third wall of the second door.

The third wall of the second door may be substantially perpendicular to the first wall of the second door and the second wall of the second door.

The first edge of the first door and second edge of the first door may be substantially parallel.

The first edge of the second door and second edge of the second door may be substantially parallel.

The cabinet may include a second ledge portion on the second door.

The second ledge portion may be located on a fourth edge of the second door.

The first ledge portion, the second ledge portion, or both the first and second ledge portions may be capable of connecting to a pole or wall.

The one or more knob structures may be capable of engaging with an opening in a threaded screw relationship.

The cabinet may include two or more knob structures, or even three or more knob structures.

The teachings herein also envision use of the cabinet described herein to house an electronic device where images are displayed on the electronic device to be viewed by customers in a vehicle.

The teachings herein are also directed to a method comprising: providing a back portion including a screen surface and having a first, second, and third edge; locating one or more retaining arm assemblies onto the third edge of the back portion, the one or more retaining arm assemblies including a retaining arm having a projection; connecting a first and second door to the back portion via one or more hinges, the first and second door also including a first, second, and third edge, wherein the back portion and first and second doors form a cabinet; forming a slot portion in the third edge of one or more of the first and second door; and locating the projection into the slot portion so that the first door, second door, or both are maintained in an engaged and open position.

The first door and second door may include inner surfaces that are a visible when the doors are in an open position and capable of receiving images that are electronic, static or some combination thereof.

### BRIEF DESCRIPTION OF THE DRAWINGS

FIG. 1 is a perspective view of an exemplary cabinet in a closed position in accordance with the present teachings.

FIG. 2 is a perspective view of the cabinet of FIG. 1 in an open position.

FIG. 3 is a rear perspective view of the cabinet of FIG. 1.

FIG. 4 is a front elevation view of the cabinet of FIG. 1 in a closed position.

FIG. 5 is a rear elevation view of the cabinet of FIG. 1 in a closed position

FIG. 6 is a plan view of the cabinet of FIG. 1 in a closed position.

FIG. 7 is a bottom view of the cabinet of FIG. 1 in a closed position.

FIG. 8 is a side elevation view of the cabinet of FIG. 1 in a closed position.

FIG. 9 is an opposing side elevation view of the cabinet of FIG. 1 in a closed position.

FIG. 10 is a close-up view of an exemplary retaining arm assembly in accordance with the present teachings.

FIG. 11 is an opposing close-up view of the retaining arm assembly of FIG. 10.

FIG. 12 is an exploded view of the retaining arm assembly of FIG. 10.

FIG. 13 is a perspective view of an exemplary retaining arm moving from a disengaged position toward an engaged position.

FIG. 14 is a perspective view of the retaining arm of FIG. 13 in an engaged position.

FIG. 15 is a perspective view of an exemplary cabinet in a closed position in accordance with the present teachings.

FIG. 16 is a rear perspective view of the cabinet of FIG. 15.

FIG. 17 is a perspective view of the cabinet of FIG. 15 in an open position.

FIG. 18 is a close-up view of an exemplary hinge portion in accordance with the present teachings.

FIG. 19 is a close-up view of an exemplary ledge portion in accordance with the present teachings.

FIG. 20 is a rear elevation view of the cabinet of FIG. 15.

FIG. 21 is a cross-section view along line 7-7 of FIG. 20.

FIG. 22 is a cross-section view along line 8-8 of FIG. 20.

FIG. 23 is a close-up view within circle 9 of FIG. 22 of an exemplary knob device accordance with the present teachings.

FIG. 24 is a front elevation view of the cabinet of FIG. 15.

FIG. 25 is a rear elevation view of the cabinet of FIG. 15.

FIG. 26 is a plan view of the cabinet of FIG. 15.

FIG. 27 is a bottom view of the cabinet of FIG. 15.

FIG. 28 is side elevation view of the cabinet of FIG. 15.

FIG. 29 is an opposing side elevation view of the cabinet of FIG. 15.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The cabinet structures described herein include at least two doors. The cabinet may have a back portion or may be free of a back portion. The cabinet may have a latch device, clip, or knob structures to assist in maintaining the doors in a closed position. The cabinet may have a space to receive a sign, an electronic device, or some combination thereof. The cabinet may allow for easy access to electronic circuitry of an electronic device. The cabinet may allow for easy access to signage within the cabinet. The cabinet may be capable of moving from an engaged open position to a disengaged position. In the disengaged position the doors are capable of being closed and latched across the front of the cabinet or open and wrapped around the back of the cabinet.

Any reference herein to an electronic device may include non-electronic (manual) devices as well. Any reference herein to a screen may indicate an electronic screen or a screen with no electrical connectivity. Device for signage described herein may include, a television, a computer screen, an iPad or other larger screen mobile device, a traditional mobile device, a paper or plastic device, a device for receiving removable letters or removable images, a device for receiving printed material, or a device for receiving adhesive-backed materials.

In one particular embodiment, the back portion may include an electronic screen on its inner panel with messages that change at regular intervals. While the cabinet is in engaged position, the inner panels of the first and second doors may be open and visible as display panels where printed, digital, adhesive, or other types of signage may be located.

In another embodiment, the cabinet may include only two doors and no back portion. The second door may be opened by twisting one or more knobs to reveal a back panel of an electronic device or other signage so that repairs, replacements, or changes can be made.

The cabinets described herein may have fastening devices that secure the doors to protect the signage contents therein. These fastening devices may be fitted with locks for additional security. Other fastening devices may be utilized throughout the cabinet as well. Any of these fastening device may be friction fit, snap fit, hook and catch, bolts, threaded screw fasteners, tree fasteners, or the like.

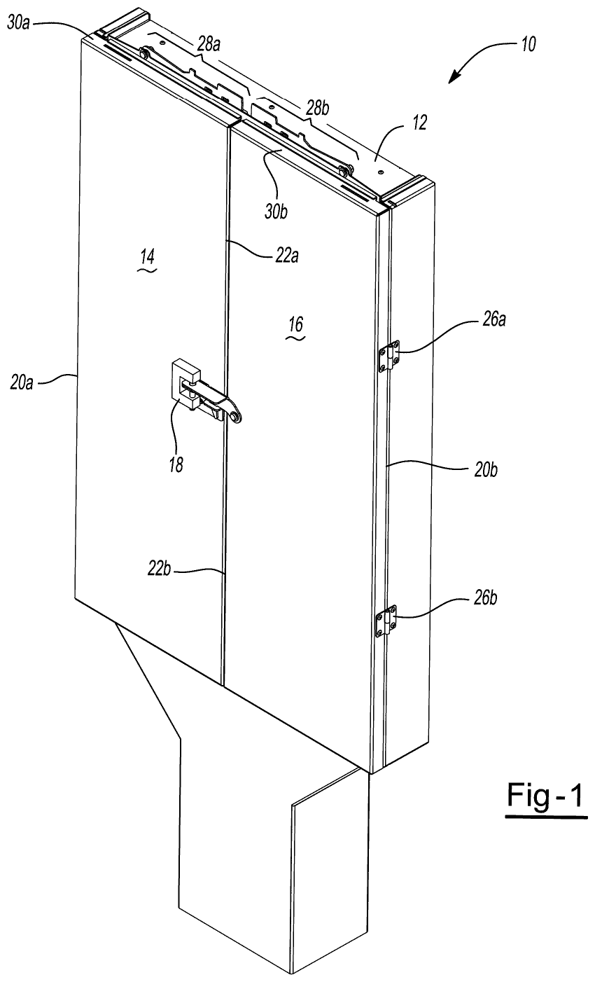

As shown for example in FIG. 1, the cabinet 10 includes a back portion 12, a first door 14, and a second door 16. A latch 18 connects to the first door 14 and second door 16 for maintaining the doors in a closed position. The first door 14 includes a first edge 20a and a second edge 22a. The second door 16 includes a first edge 20b and a second edge 22b. The cabinet rests on a base 24. Hinges 26a, 26b connect the second door 16 to the back portion 12. A first retaining arm assembly 28a and a second retaining arm assembly 28b are located on the back portion 12 but adjacent a third edge 30a of the first door, and a third edge 30b of the second door when the doors are in a closed position.

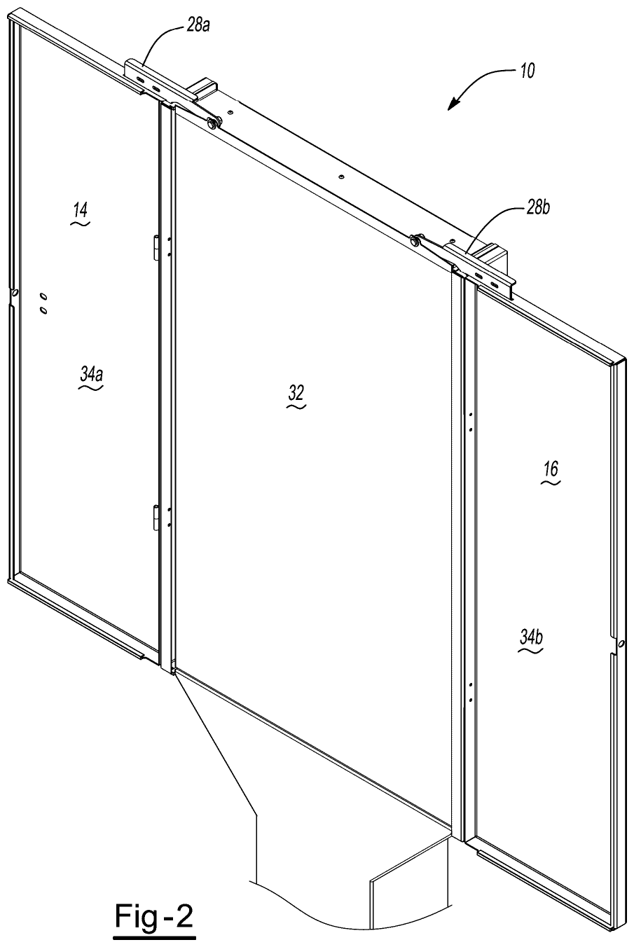

FIG. 2 shows the cabinet 10 with the doors 14, 16 locked in an open position via the retaining arm assemblies 28a, 28b being in an engaged position. A screen 32 is visible with a first door inner surface 34a and second door inner surface 34b also visible.

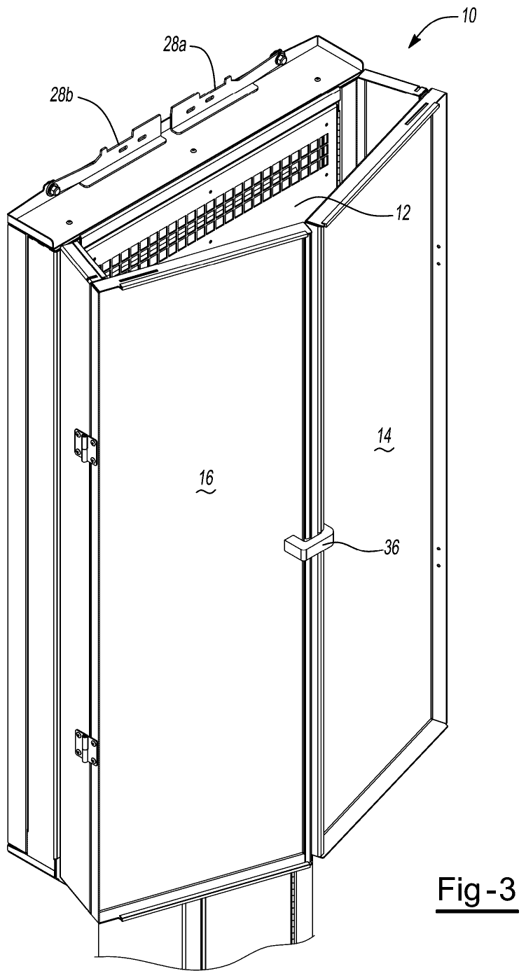

FIG. 3 shows the cabinet 10 with the retaining arm assemblies 28a, 28b being in a disengaged position such that the first door 14 and second door 16 are capable of opening and wrap behind the back portion 12. A clip device 36 is shown connecting the first door 14 and second door 16 to assist in maintaining the doors in the inverse closed position.

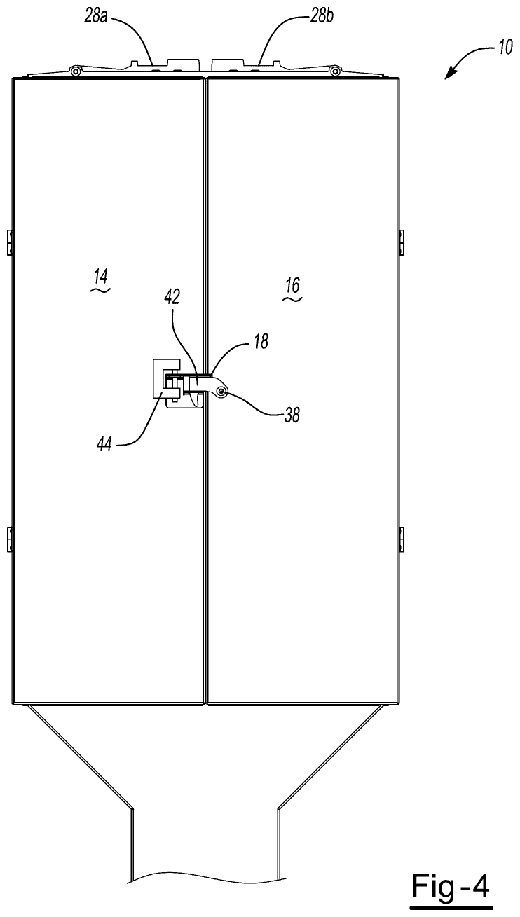

FIG. 4 shows the cabinet 10 in the closed position with the latch 18 including a post 38 attached to the second door 16, the post receiving an opening 40 in a hook 42 that mechanically interlocks with a catch 44. The catch 44 is fastened to the first door 14. When the cabinet is in the closed position, the retaining arm assemblies 28a, 28b are in a disengaged position.

FIG. 5 shows the back portion 12 including a plurality of knobs 46a, 46b, 46c. The back portion includes an access door 48 where the screen (not shown) can be accessed. The access door 48 includes a plurality of vent structures 50.

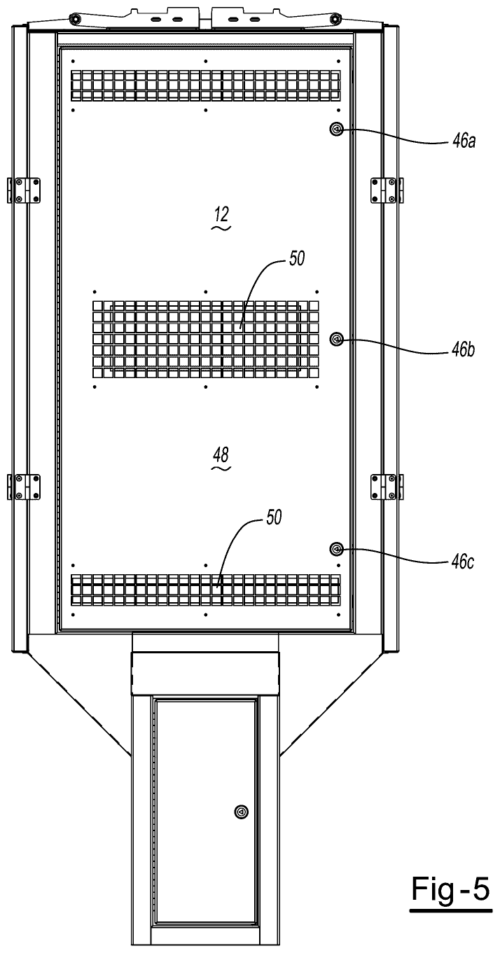

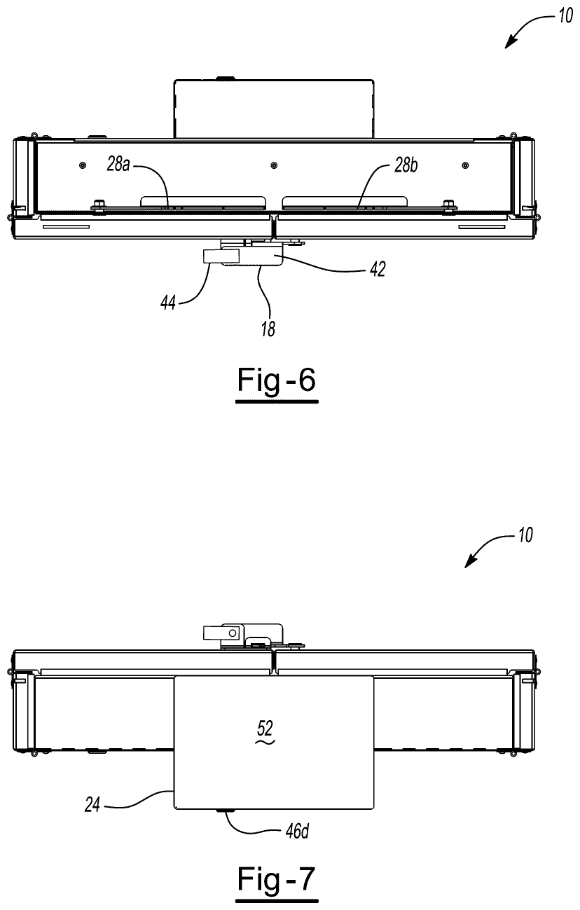

FIG. 6 shows the cabinet 10 from above with the retaining arm assemblies 28a, 28b in a disengaged position and the latch 18 having the hook 42 engaged within the catch 44.

FIG. 7 shows the cabinet 10 from below with the base 24. The base 24 may also include a knob 46d attached to a door (not visible) which door can provide access to a space 52 within the base 24.

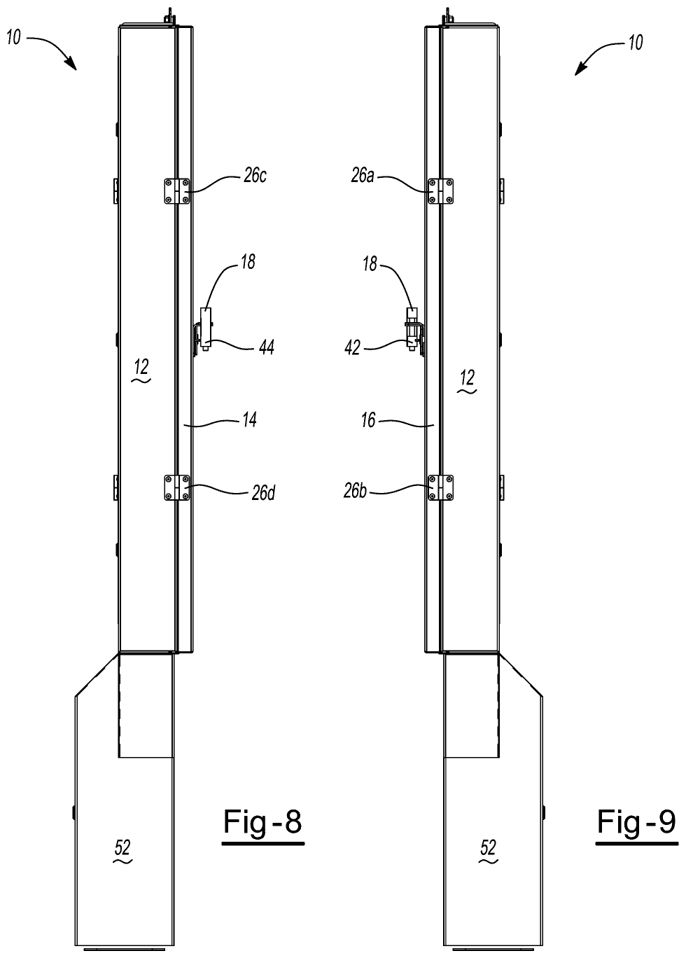

FIGS. 8 and 9 show the cabinet 10 from opposing sides such that the back portion 12, first door 14, second door 16, latch 18, base 24, hinges 26a, 26b, 26c, 26d, hook 42, and catch 44 are all visible.

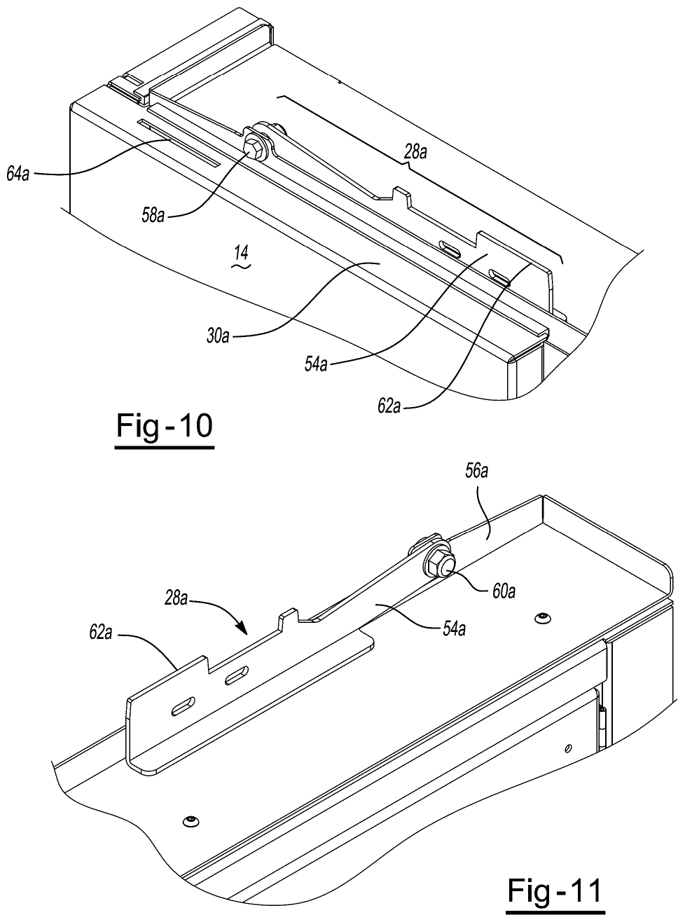

FIGS. 10 and 11 show additional detail of the retaining arm assembly 28a including a retaining arm 54a, a parallel wall 56a separate from but lying parallel to and adjacent the retaining arm. The retaining arm 54a is attached to the parallel wall 56a via a first bolt 58a and second bolt 60a engaged within an opening 61a in the parallel wall 56a and an opening 61b in the retaining arm 54a. The retaining arm 54a includes a protrusion 62a that is capable of being received within a slot portion 64a of the third edge of a door 30a when the door is in an open position.

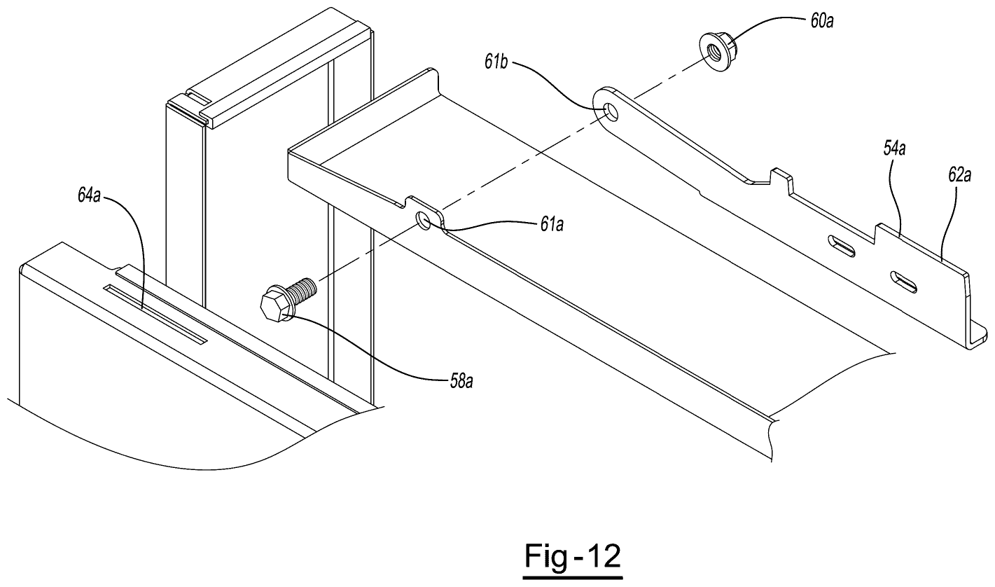

FIG. 12 shows the retaining arm assembly 28a in an exploded view where the retaining arm 54a, parallel wall 56a, first bolt 58a, and second bolt 60a prior to full assembly.

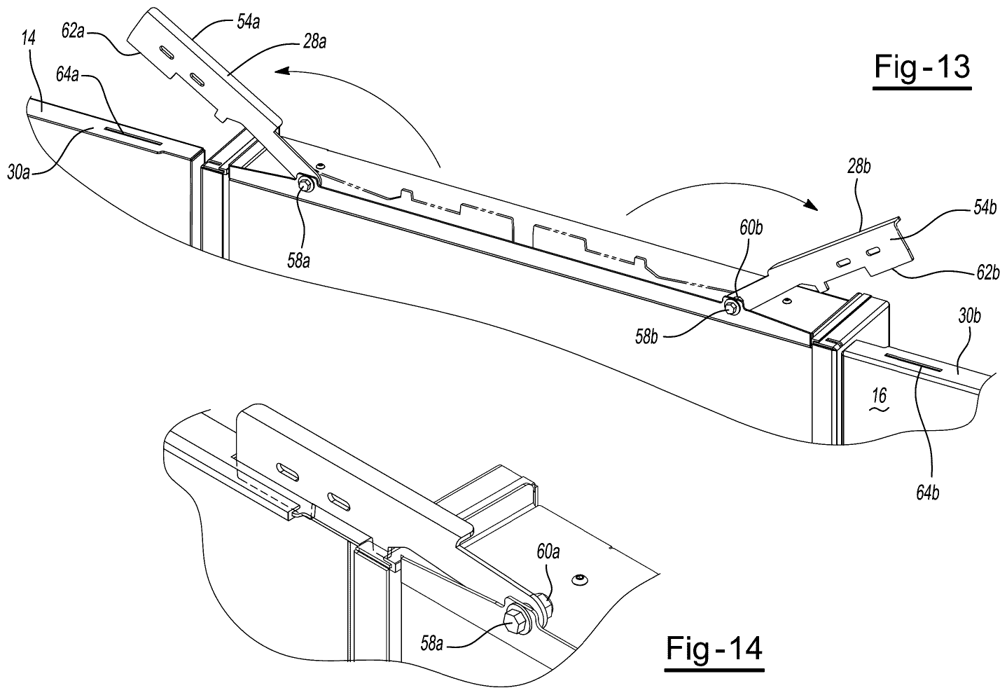

As shown in FIGS. 13 and 14, the retaining arms 54a, 54b can be maneuvered about the first and second bolts 58a, 58b, 60a, 60b to be located from a disengaged position to an engaged position (see arrow indicator in FIG. 13). Upon approaching the engaged position, the protrusion 62a, 62b is received by the slot portion 64a, 64b in the third edge 30a, 30b of the doors 14, 16.

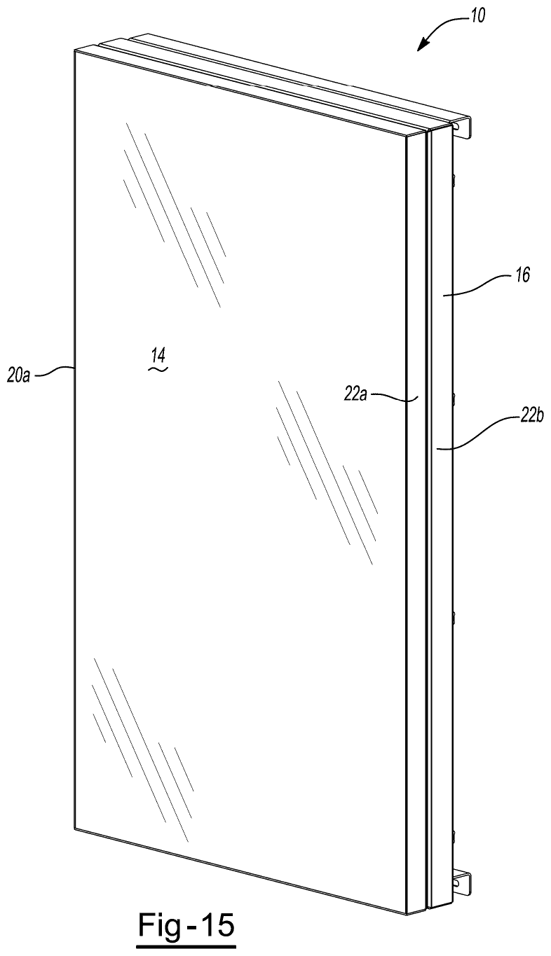

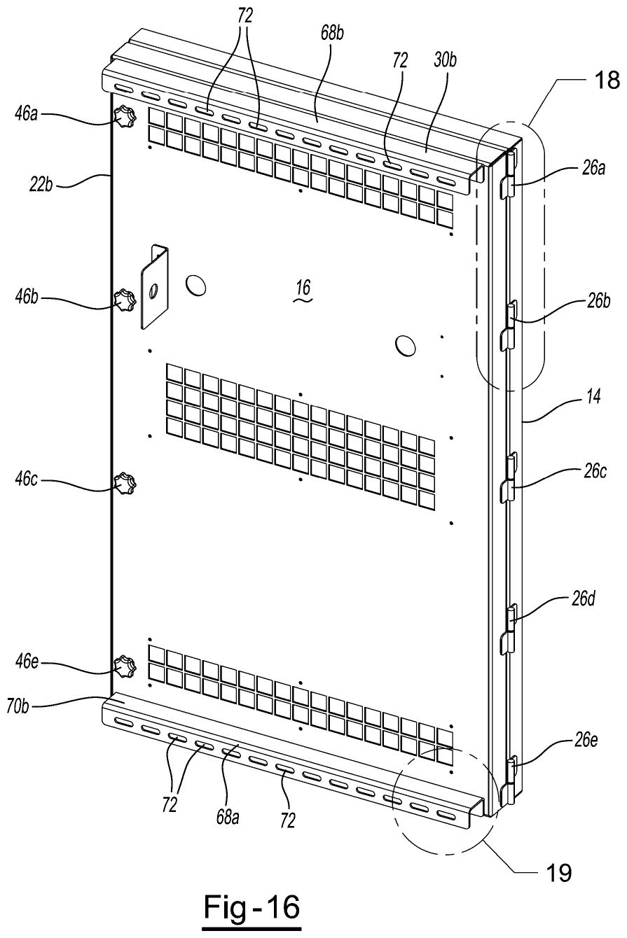

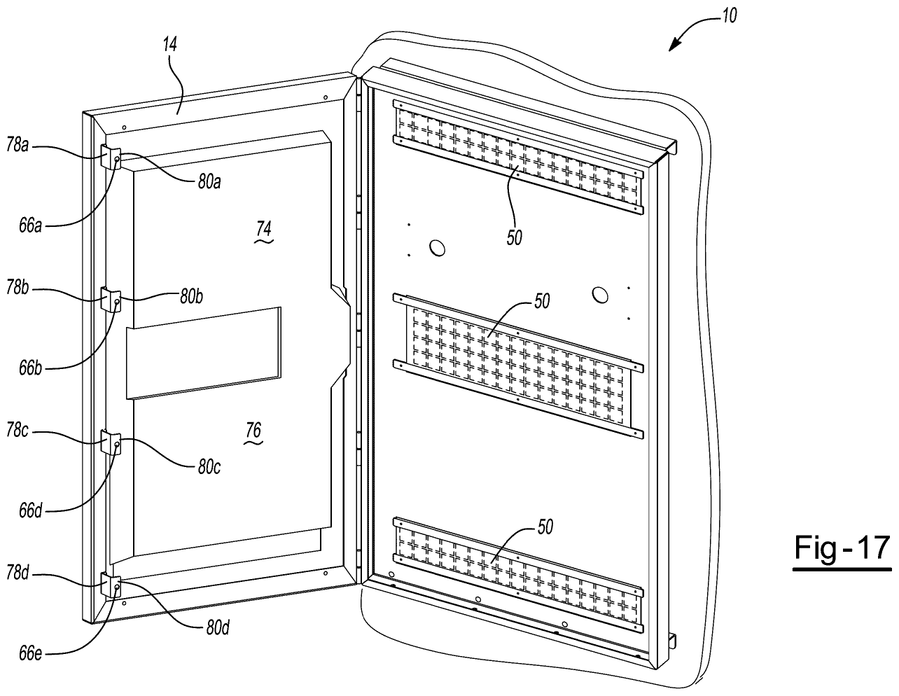

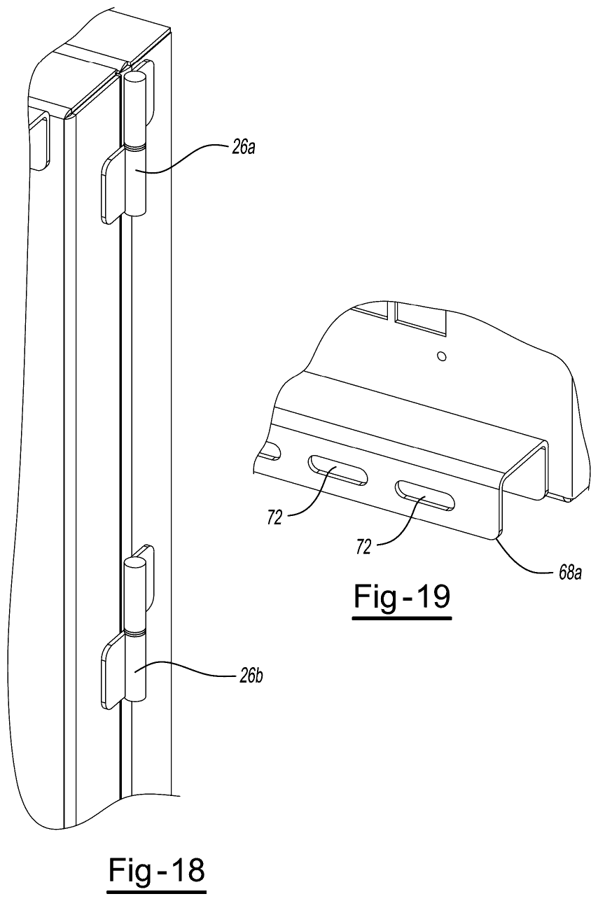

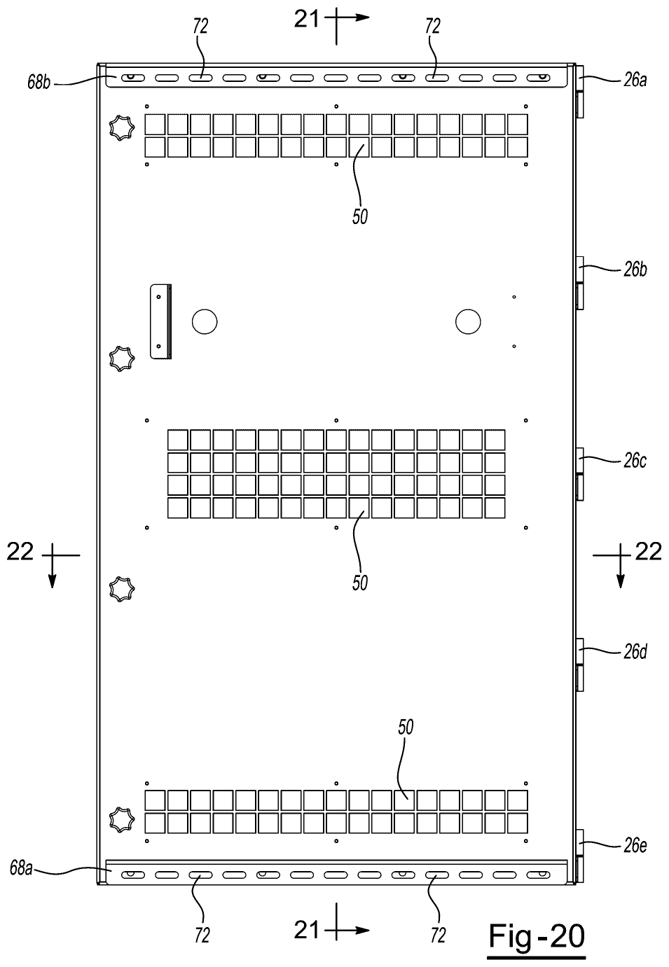

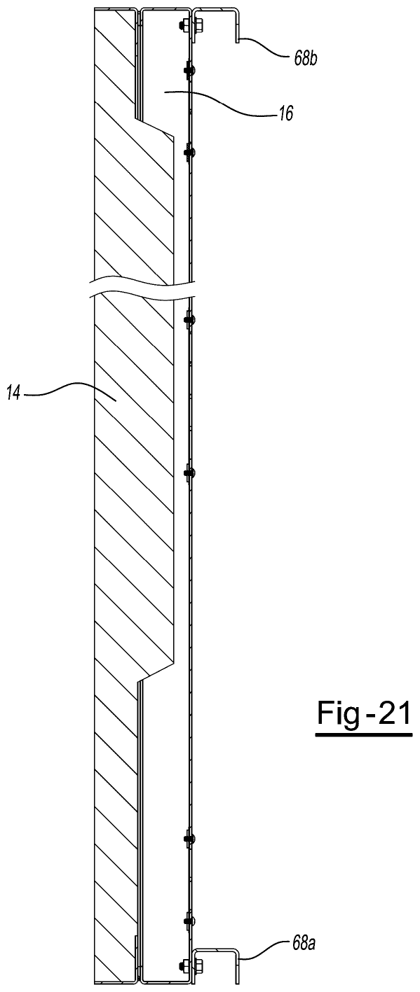

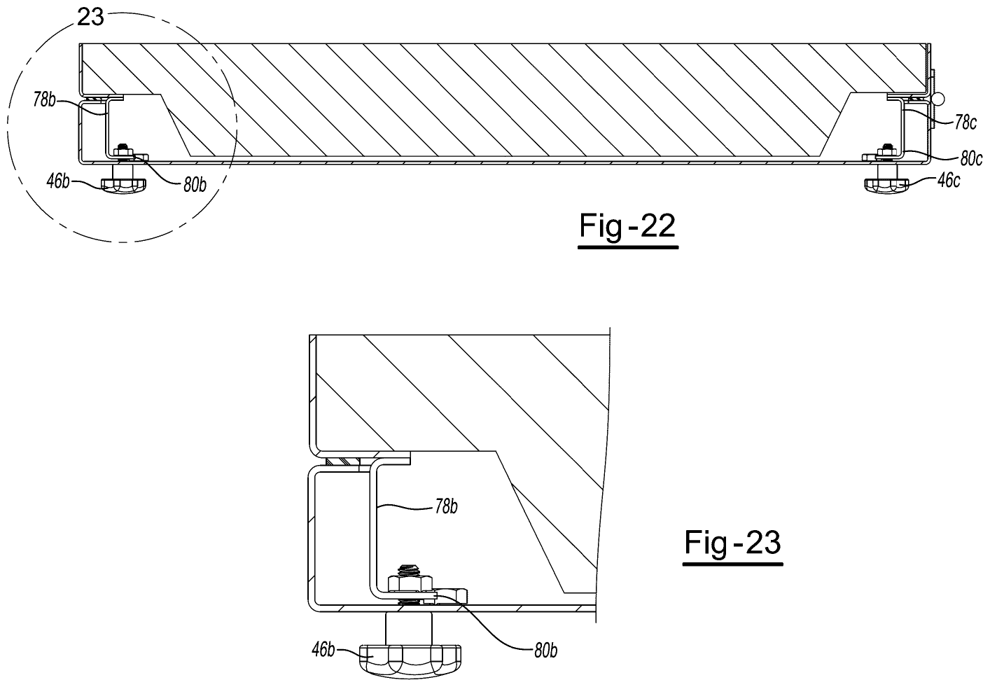

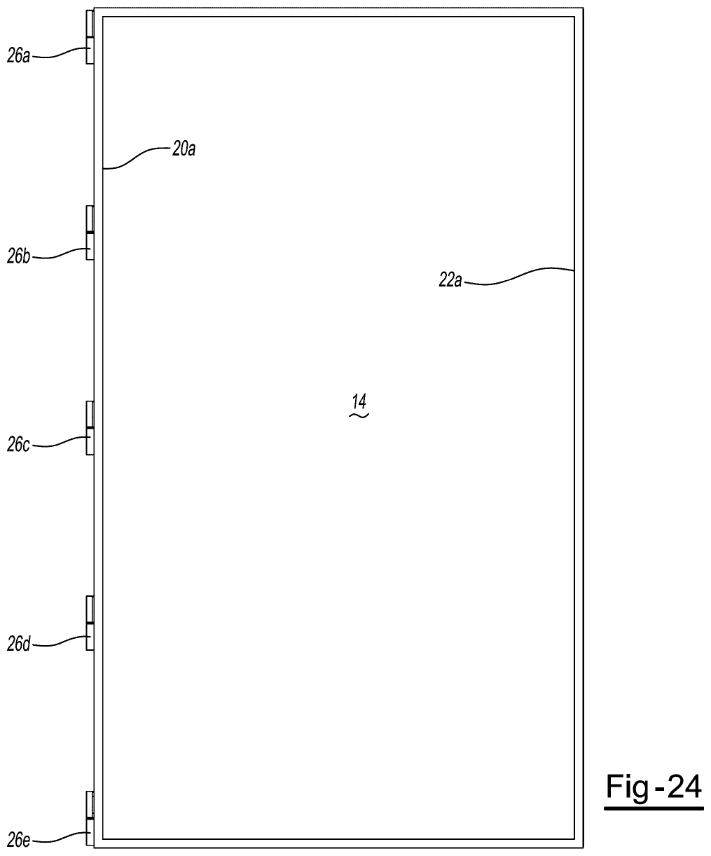

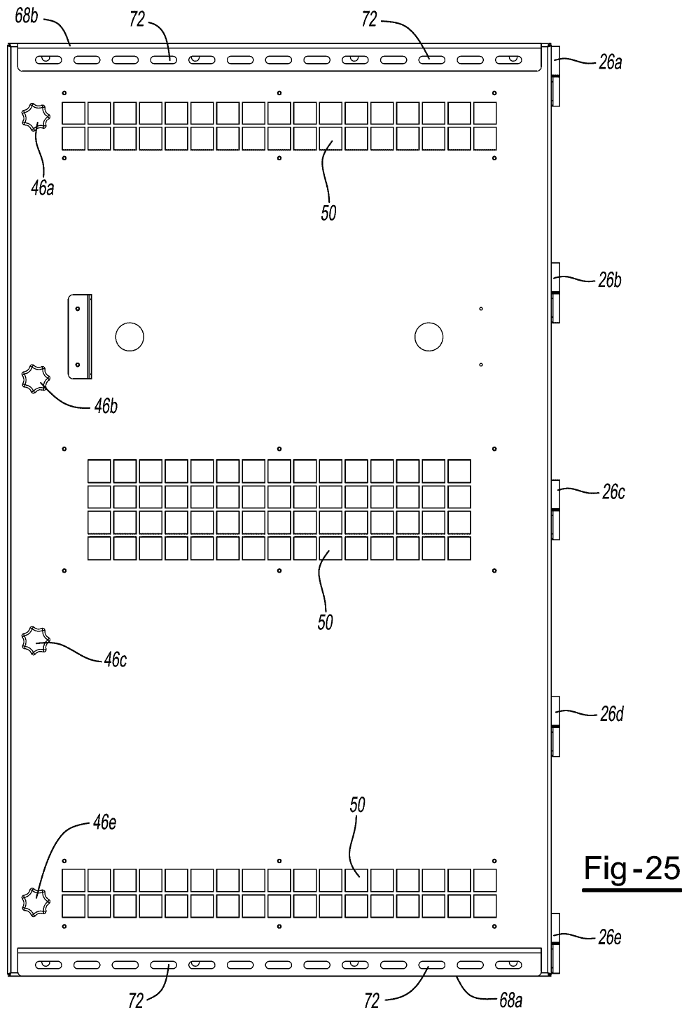

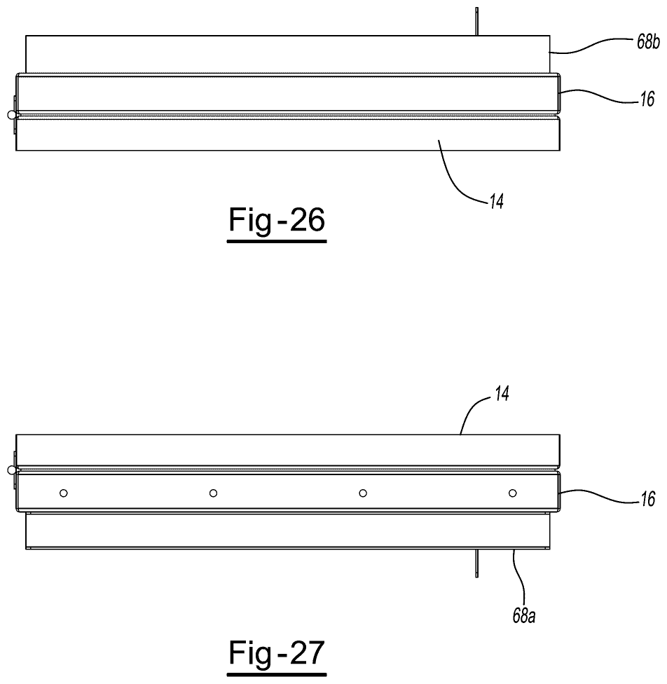

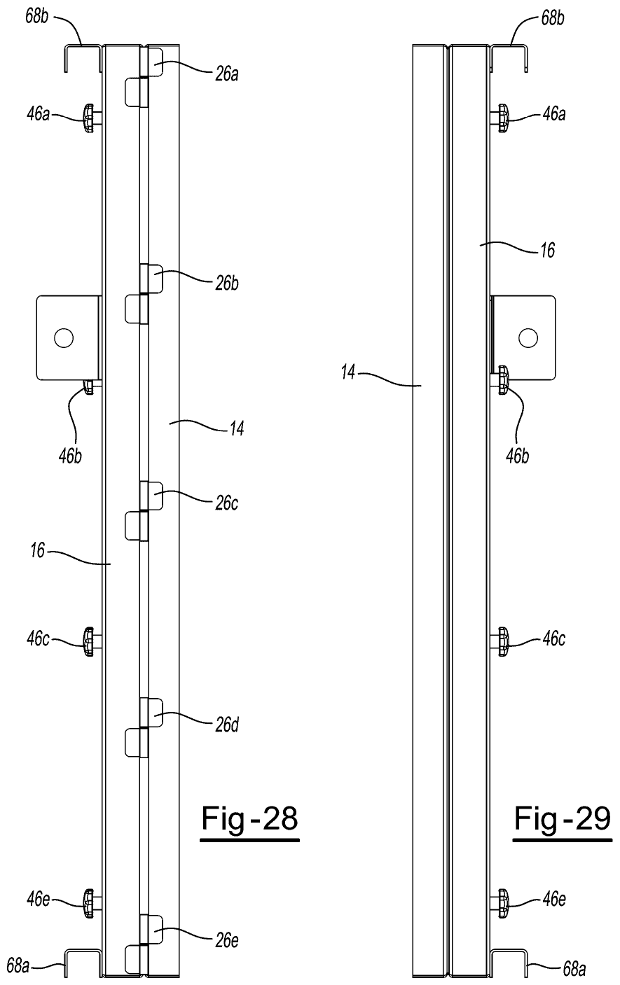

FIGS. 15-29 depict another embodiment of the cabinet described herein. The cabinet 10 includes a first door 14, and a second door 16. The first door 14 includes a first edge 20a and a second edge 22a. The second door 16 includes a first edge 20b and a second edge 22b. A series of knobs 46a, 46b, 46c, 46e are located on a second edge 22b of the second door 16. The knobs are capable of being received by corresponding threaded openings 66a, 66b, 66c, 66d located in the second edge 22b of the first door 14. Hinges 26a, 26b, 26c, 26d, 26e connect the first door 14 to the second door 16.

A first ledge portion 68a is located along a bottom (fourth) edge 70b of the second door 16. A second ledge portion 68b is located along the third edge 30b of the second door. Each of the first and second ledge portions 68a, 68b are shown including a plurality of openings 72.

A space 74 for receiving an electronic device 76 is located within the first door 14. The space is formed by a plurality of extending walls 78a, 78b, 78c, 78d that extend away from the second edge 22a of the first door 14 and a plurality of corner walls 80a, 80b, 80c, 80d that are connected to the extending walls 78a, 78b, 78c, 78d but lie in a substantially perpendicular relationship with the plurality of extending walls. The electronic device 76 may slide into the space 74 from above the cabinet 10 and may be prevented from extending below the fourth edge 70a of the first door by a wall 74 extending in a direction parallel to the fourth edge 70a of the first door. Upon locating the electronic device 76 into the space 74, the extending walls 78a, 78b, 78c, 78d and corner walls 80a, 80b, 80c, 80d prevent lateral movement of the electronic device 76.

The second door 16 includes a plurality of vent structures 50. The first ledge portion 68a and second ledge portion 68b may be capable of connecting via the plurality of openings 72 to a wall, a pole, or some other base structure (not shown) depending on the height and location desired for viewing what is on the electronic device 76.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the comparative teaching of amounts expressed as weight/volume percent for two or more ingredients also encompasses relative weight proportions of the two or more ingredients to each other, even if not expressly stated. For example, if a teaching recites 2% A, and 5% B, then the teaching also encompasses a weight ratio of A:B of 2:5. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes.

The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of (namely, the presence of any additional elements, ingredients, components or steps, does not materially affect the properties and/or benefits derived from the teachings; or even consist of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1: A cabinet comprising:
a back portion having a first, second, and third edge;
a first door connected to the back portion via one or more hinges including a first edge of the first door and a second edge of the first door;
a second door connected to the back portion via one or more hinges wherein the one or more hinges are located in contact with the first edge of the first door and a first edge of the second door;
one or more retaining arm assemblies located at a third edge of the back portion, wherein one or more retaining arm assemblies are capable of moving between a disengaged position and an engaged position;
a space formed in the back portion capable of receiving a screen;
wherein when the one or more retaining arm assemblies is in the engaged position the first door, the second door, or both are secured in an open position and when the one or more retaining arm is in the disengaged position, the first door, the second door, or both are able to move between an open and closed position.

2: The cabinet of claim 1, wherein the one or more retaining arm assemblies include a retaining arm, the retaining arm including a projection that is capable of being received by a slot portion located along a third edge of the first door and second door when in the engaged position.

3: The cabinet of claim 1, wherein the one or more retaining arm assemblies include a parallel wall having an opening located therein for receiving a fastener.

4: The cabinet of claim 3, wherein the fastener includes one or more bolts.

5: The cabinet of claim 4, wherein the retaining arm swings about the one or more bolts to move from the disengaged position to the engaged position.

6: The cabinet of claim 1, wherein the first and second doors are capable of opening in the disengaged position and extend around the back portion to be fastened together behind the back portion.

7: The cabinet of claim 1, including a latch for maintaining the first and second door in a closed position.

8: The cabinet of claim 7, wherein the latch includes a hook and catch for receiving the hook.

9: The cabinet of claim 8, wherein the hook is located on the second door and the catch is located on the first door.

10: A cabinet comprising:
a first door including a first edge of the first door and a second edge of the first door;
a second door connected to the first door via one or more hinges wherein the one or more hinges are located in contact with the first edge of the first door and a first edge of the second door;
one or more knob structures for mechanically interlocking the second edge of the first door with a second edge of the second door;
a first ledge portion attached to an edge of the second door, the first ledge portion including one or more openings;
a space formed in the first door capable of receiving an electronic device, the space being defined by a plurality of wall structures that are capable of preventing lateral movement and provide support from below to maintain the electronic device within the space
wherein the wall structures include a plurality of extending walls that extend away from the second edge of the first door and a plurality of corner walls that are connected to the extending walls but lie in a substantially perpendicular relationship with the plurality of extending walls.

11: The cabinet of claim 10, wherein the ledge portion is attached to a third wall of the second door.

12: The cabinet of claim 10, wherein the third wall of the second door is substantially perpendicular to the first wall of the second door and the second wall of the second door.

13: The cabinet of any of claim 12, wherein the first edge of the first door and second edge of the first door are substantially parallel.

14: The cabinet of any of claim 13, wherein the first edge of the second door and second edge of the second door are substantially parallel.

15: The cabinet of claim 10 including a second ledge portion on the second door.

16: The cabinet of claim 15, wherein the second ledge portion is located on a fourth edge of the second door.

17: The cabinet of claim 15, wherein the first ledge portion, the second ledge portion, or both the first and second ledge portions are capable of connecting to a pole or wall.

18: The cabinet of claim 10, wherein the one or more knob structures are capable of engaging with an opening in a threaded screw relationship.

19: A method comprising:
providing a back portion including a screen surface and having a first, second, and third edge;
locating one or more retaining arm assemblies onto the third edge of the back portion, the one or more retaining arm assemblies including a retaining arm having a projection;
connecting a first and second door to the back portion via one or more hinges, the first and second door also including a first, second, and third edge, wherein the back portion and first and second doors form a cabinet;
forming a slot portion in the third edge of one or more of the first and second door;
locating the projection into the slot portion so that the first door, second door, or both are maintained in an engaged and open position.

20: The method of claim 19, wherein the first door and second door include inner surfaces that are a visible when the doors are in an open position and capable of receiving images that are electronic, static or some combination thereof.
